(19) United States
(12) Patent Application Publication
(10) Pub. No.: US 2002/0145580 A1
(43) Pub. Date: Oct. 10, 2002

(54) Minimizing frame writing time of a liquid crystal display

(76) Inventor: John Karl Waterman, Mesa, AZ (US)

Correspondence Address: PAUL N. KATZ, BAKER BOTTS L.L.P., ONE SHELL PLAZA, 901 LOUISIANA STREET, HOUSTON, TX, 77002-4995, US

(21) Appl. No.: 09/827,559

(22) Filed: Apr. 6, 2001

(51) Int. Cl. G09G 3/36

(52) U.S. Cl. 345/89; 345/98

(57) ABSTRACT

A liquid crystal display (LCD) comprising a matrix of pixels has a border surrounding a video frame. The border comprises top and bottom rows of pixels, and left and right portions of the rows of pixels comprising the video frame. Border pixels of each row are written to independently of valid video information until a pixel on a row requiring video frame information is addressed. After each time a row of pixels comprising the video frame is written, border pixels of that row and a next row are written to independently of the availability of valid video information. Multiple top and bottom border rows of pixels may be written to simultaneously, and a plurality of pixels in each of these rows may be written to simultaneously. All border pixels may be written to before valid video information for the video pixels is available.

### FIELD OF THE INVENTION

The present invention relates generally to liquid crystal display devices, and more particularly to a system, apparatus and method for minimizing frame writing time by prewriting border pixels while waiting for pixel video line data.

### BACKGROUND OF THE INVENTION TECHNOLOGY

Liquid crystal displays (LCDs) are commonly used in devices such as portable televisions, portable computers, control displays, and cellular phones to display information to a user. LCDs act in effect as a light valve, i.e., they allow transmission of light in one state, block the transmission of light in a second state, and some include several intermediate stages for partial transmission. When used as a high resolution information display, as in one application of the present invention, LCDs are typically arranged in a matrix configuration with independently controlled display areas called “pixels” (the smallest segment of the display). Each individual pixel is adapted to selectively transmit or block light from a backlight (transmission mode), from a reflector (reflective mode), or from a combination of the two (transflective mode).

A LCD pixel can control the transference for different wavelengths of light. For example, an LCD can have pixels that control the amount of transmission of red, green, and blue light independently. In some LCDs, voltages are applied to different portions of a pixel to control light passing through several portions of dyed glass. In other LCDs, different colors are projected onto the area of the pixel sequentially in time. If the voltage is also changed sequentially in time, different intensities of different colors of light result. By quickly changing the wavelength of light to which the pixel is exposed an observer will see the combination of colors rather than sequential discrete colors. Several monochrome LCDs can also result in a color display. For example, a monochrome red LCD can project its image onto a screen. If a monochrome green and monochrome blue LCD are projected in alignment with the red, the combination will be a full range of colors.

The monochrome resolution of an LCD can be defined by the number of different levels of light transmission or reflection that each pixel can perform in response to a control signal. A second level is different from a first level when a user can tell the visual difference between the two. An LCD with greater monochrome resolution will look clearer to the user.

LCDs are actuated pixel-by-pixel, either one at a time or a plurality simultaneously. A voltage is applied to each pixel area by charging a capacitor formed in the pixel area. The liquid crystal responds to the charged voltage of the pixel capacitance by twisting and thereby transmitting a corresponding amount of light. In some LCDs an increase in the actuation voltage decreases transmission, while in others it increases transmission. When multiple colors are involved for each pixel, multiple voltages are applied to the pixel at different positions (different capacitance areas being charged of a pixel) or times depending upon the LCD illumination method. Each voltage controls the transmission of a particular color. For example, one pixel can be actuated for only blue light to be transmitted while another for green light, and a third for red light. A greater number of different light levels available for each color results in a much greater number of possible color combinations. Colors may be combined from a red pixel, a green pixel and a blue pixel, each residing on a different LCD, to produce any desired combined pixel color. The three LCDs (red-green-blue or RGB) are optically aligned so that the resulting light from each of the corresponding RGB pixels produces one sharp color pixel for each of the pixels in the LCD pixel matrix. The LCD pixel matrix is adapted for displaying one frame of video per light strobe. Each light strobe (RGB) produces one video frame. A sequence of video frames produces video images that may change over time (e.g., motion video).

Converting a complex digital signal that represents an image or video into voltages to be applied to charge the capacitance of each pixel of an LCD involves circuitry that can limit the monochrome resolution. The signals necessary to drive a single color of an LCD are both digital and analog. It is digital in that each pixel requires a separate selection signal, but it is analog in that an actual voltage is applied to charge the capacitance of the pixel in order to determine light transmission thereof.

Each pixel in the array of the LCD is addressed by both a column (vertical) driver and a row (horizontal) driver. The column driver turns on an analog switch that connects an analog voltage representative of the video input (control voltage necessary for the desired liquid crystal twist) to the column, and the row driver turns on a second analog switch that connects the column to the desired pixel.

The video inputs to the LCD are analog signals centered around a center reference voltage of typically from about 7.5 to 8.0 volts. A voltage called “VCOM” is not a supply voltage or signal from anywhere, but typically is a few hundred millivolts below the center reference voltage. VCOM is adjusted for best image quality, e.g., minimum flicker and/or image sticking. The center reference voltage connects to the LCD cover glass electrode which is a transparent conductive coating on the inside face (liquid crystal side) of the cover glass. This transparent conductive coating is typically Indium Tin Oxide (ITO).

One frame of video pixels are run at voltages above the center reference voltage (positive inversion) and for the next frame the video pixels are run at voltages below the center reference voltage (negative inversion). Alternating between positive and negative inversions results in substantially a zero net DC bias at each pixel. This substantially reduces the “image sticking” phenomena.

Writing video voltage values to each pixel in, for example, an 800×600 (SVGA) frame takes about 2 milliseconds using 8 analog channels (DACs) in parallel operation, with each analog channel given about 25 nanoseconds to apply the appropriate video voltage value to each of its set of pixels of the SVGA frame. Unfortunately, the liquid crystal material itself takes about 3 to 4 milliseconds to settle to within one percent of its final reflectivity. That leaves very little time to flash the light source (for example: light emitting diodes—LED) for the illumination step.

In a simultaneous three color LCD projection system, either rear or front projection, three LCD displays are used. One for red, one for green and one for blue images which are combined in an optics system to produce a full color frame of video. Each LCD display may be fabricated on a semiconductor integrated circuit to produce a “microdisplay” such as a “liquid crystal on silicon” or “LCOS” microdisplay. The three microdisplays are precisely located in relation to optical lenses and the red, green and blue light sources to produce a full color video frame. Generally, there is a black (no light reflectance or transmittance) border surrounding the LCD and the physical locations of the three microdisplays are coarsely aligned so as to converge the red, green and blue light frames (matrix of pixels) into one full color frame. A fine alignment of the three microdisplays in relation to each other is performed by writing row and column pixels to black (no light reflectance or transmittance) near the border inside edges of each microdisplay. The video border of each microdisplay may be shifted by increments of one pixel up, down, left or right to bring into color alignment the RGB color frame images from the three microdisplays.

A LCD pixel matrix may comprise 1200 columns by 1024 rows, 1920 columns by 1200 rows, etc. The number of pixels in the LCD is the product of the number of rows times the number of columns. A large number of pixels must therefore be addressed and voltage charged (written) for each frame of video desired. This takes time, therefore, minimizing the time required for writing to the pixels comprising a frame of video and boarders is both advantageous and highly desirable.

### SUMMARY OF THE INVENTION

The present invention overcomes the above-identified problems as well as other shortcomings and deficiencies of existing technologies by providing a system, method and apparatus for minimizing the time required to a frame of video information to a matrix of pixels in a liquid crystal display (LCD). In accordance with exemplary embodiments of the present invention, a frame image on an LCD, e.g., a microdisplay is surrounded by a black (substantially no light reflectance or transmittance) border of pixels which may be used for fine adjustment of the physical alignment of the video frame of the LCD, e.g., the alignment of the three LCDs (color convergence) in an RGB color display system. The width of an edge of the black pixel border can be varied to move the video frame left or right, up or down by one pixel column or row, respectively, at a time. The black pixel border may comprise any number of pixels. For example a border side may be five pixels in width, therefore the video frame may be shifted up or down by five pixel rows, and/or shifted left or right by five pixel columns. In addition, the embodiments of the invention may be used to change the aspect ratio, e.g., 4/3, 5/4, 16/9, etc., of the LCD display by increasing or decreasing the number of black pixels in the appropriate portions of the border. The black pixel border in combination with the mechanical border surrounding the LCD pixel matrix comprises the total border surrounding the video frame created by the pixels representing the video image.

The LCD of the present invention may have its matrix of pixels and associated support electronics, e.g., row and column selection switches and drivers, analog switches, and the like fabricated onto a semiconductor integrated circuit die, e.g., a microdisplay. The electronics controller may be fabricated on one or more semiconductor integrated circuit dice and connected to the LCD electronics.

In an exemplary embodiment of the invention, portions of the black pixel border may be written without having to wait for the receipt and processing of video information needed to write the rows of video pixels (gray scale pixels in the active video image area). In effect, black pixel voltage values are written as soon as possible to all pixels in the black pixel border rows and the pixels in the portions of each row comprising the black pixel border columns. The pixels in the pixel border columns are before and after the first and last pixels of the row, respectively, requiring updated video grayscale values. This reduces the time required to write a frame of video (image).

In an LCD pixel matrix of N rows and M columns, pixel rows may be written in any order, e.g., rows 1, 2, 3 . . . N; 1, 3, 5 . . . N−1, 2, 4, 6 . . . N; reversed or randomly. Each of the pixel rows is connected, one row of pixels at a time to the columns (each column to a respective pixel in the row) which are charged to desired gray scale (including black) voltages for each of the pixels on the connected (selected) row. The columns may be written in any order (sequentially or non-sequentially), e.g., 1, 2, 3 . . . M; M . . . 3, 2, 1; or in small groups (4, 8, etc.) thereof depending upon the number of digital-to-analog converters (DACs) available in the LCD system.

At the end of a frame of video information, the bottom black border pixels are written and, then after the polarity change (positive or negative inversion), the top black border pixels may be immediately written thereto. Alternating between positive and negative inversions is necessary to prevent build up of a dc charge which causes image sticking. The pixels in the border columns of the first row of pixels comprising video information are also written to and then the writing stops at the pixel requiring new video information. Hereinafter this point shall be referred to as “vertical wait” or “VW.” Writing resumes after VW once the first line (row) of valid video information is available. Then as the pixels in each line of the frame are written, the trailing (right) border pixels are written, the next line is started and the leading black border (left) is written, stopping at the first pixel of the next line requiring video information. This point shall be referred to as “horizontal wait” or “HW.” At HW the writing stops until the next valid line of video information is available to be written. Thus, leading black borders may be written before valid video information is available. Writing of the leading black border rows may start either at the top of the frame or at the left side and then stop and wait for a line of valid video information before beginning to write the frame pixels of a row. This minimizes frame writing time since the border pixels may be written when valid video information is not available.

In another exemplary embodiment, the top and bottom border rows are written to black before video frame writing begins. The rows comprising video frame information write the border pixels on those rows as disclosed above. In an LCD row and column selection order are independent and may be in any order, including random. In addition, more than one row and/or column may be selected, e.g., connected together, therefore, a plurality of rows of pixels may be written to black in one operation (step, clock, etc.). In this embodiment, a plurality of rows are connected to the columns so that all of the pixels at the intersection of those plurality of rows and columns are written to black when the columns are charged to a black voltage level. Another exemplary embodiment connects a plurality of columns together so that the pixels at the intersection of the plurality of rows connected to the plurality of columns are written to black at the same time. Connecting a plurality of rows and/or columns together to write pixels to black saves both time and power consumption in the LCD system.

The number of top and bottom rows and left and right columns comprising the black border pixels are defined after the video frame has been adjusted so as to align each microdisplay into correct color convergence.

In one embodiment of the present invention, a system is provided for minimizing frame writing time of a liquid crystal display (LCD). The system comprises a matrix of pixels arranged in a plurality of columns and a plurality of rows, wherein an intersection of a row and a column defines a location of a pixel in said matrix; at least one digital-to-analog converter (DAC) having a digital input and an analog output; a plurality of column switches adapted for coupling the analog output of said at least one DAC to each of said plurality of columns; a plurality of row switches adapted for selectively coupling each of said plurality of rows to said plurality of columns; column control logic for controlling said plurality of column switches; row control logic for controlling said plurality of row switches; a video frame to gray scale conversion and pixel address logic for converting video information into LCD gray scale values and corresponding pixel address locations thereof, said video frame to gray scale conversion and pixel address logic being adapted for sending said gray scale values to said at least one DAC, and said corresponding pixel address locations for controlling said column control logic and said row control logic; border definition logic adapted to instruct said video frame to gray scale conversion and pixel address logic which pixels are to be used as a border for other pixels of said matrix used to represent a video frame, wherein border gray scale values are written to border pixels before, during and after video gray scale values are available for writing to video frame pixels.

In another embodiment of the present invention, a method is provided for minimizing frame writing time of a liquid crystal display (LCD) comprising a matrix of pixels arranged in a plurality of rows and columns, wherein an intersection of a row and a column defines a position of a pixel in the matrix. The method comprises the steps of: (a) writing border information to pixels until reaching a pixel position requiring video information; (b) waiting until said video information is available, then writing said video information to pixels at positions requiring said video information until reaching a pixel position requiring said border information, then writing said border information to pixels at positions requiring said border information; and (c) determining if all pixels in the matrix have been written to, if not, then returning to step (a) above, and if so, then begin writing a next frame.

In another embodiment of the present invention, a method is provided for minimizing frame writing time of a liquid crystal display (LCD) comprising a matrix of pixels arranged in a plurality of rows and columns, wherein an intersection of a row and a column defines a position of a pixel in the matrix. The method comprises the steps of: (a) writing border information to pixels in at least one row until reaching a pixel position requiring video information; (b) waiting until said video information is available, then writing said video information to pixels starting at said pixel position requiring video information in said row until reaching a pixel position requiring border information, then writing border information to the remaining pixels in said row; and (c) determining if all pixel positions for all rows and columns of the matrix have been written to, if not, then returning to step (a) above, and if so, then begin writing a next frame.

In another embodiment of the present invention, a method is provided for minimizing frame writing time of a liquid crystal display (LCD) comprising a matrix of pixels arranged in a plurality of rows and columns, wherein an intersection of a row and a column defines a position of a pixel in the matrix. The method comprises the steps of: (a) writing border information to all rows of pixels not requiring video information; (b) writing border information to pixels in a row until reaching a pixel position requiring video information; (c) waiting until said video information is available, then writing said video information to pixels starting at said pixel position requiring video information in said row until reaching a pixel position requiring border information, then writing border information to the remaining pixels in said row; and (d) determining if all pixel positions for all rows and columns of the matrix have been written to, if not, then returning to step (b) above, and if so, then begin writing a next frame.

A technical advantage of the present invention is in minimizing the time required for writing a frame of a liquid crystal display. Another technical advantage is improved speed in writing a frame which reduces flicker and color-breakup artifacts. Still another technical advantage is allowing more time for writing video pixels so that the clock speed may be reduced which reduces visual artifacts that occur when operating the LCD at fast clock speeds. Other technical advantages of the present disclosure will be readily apparent to one skilled in the art from the following figures, descriptions, and claims. Various embodiments of the invention obtain only a subset of the advantages set forth. No one advantage is critical to the invention.

### BRIEF DESCRIPTION OF THE DRAWINGS

A more complete understanding of the present disclosure and advantages thereof may be acquired by referring to the following description taken in conjunction with the accompanying drawings, wherein:

FIG. 1 is a schematic block diagram of an exemplary liquid crystal display system in accordance with exemplary embodiments of the present invention;

FIG. 2 is a schematic block diagram of a portion of the liquid crystal display of FIG. 1;

FIG. 3 is a schematic block diagram of an exemplary embodiment of the invention;

FIG. 4 is a schematic diagram of fast border row writing in a LCD, according to an exemplary embodiment of the invention; and

FIG. 5 is a schematic diagram of fast border row writing in a LCD, according to another exemplary embodiment of the invention.

While the present invention is susceptible to various modifications and alternative forms, specific exemplary embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

The present invention is directed to a liquid crystal display (LCD) comprising a matrix of liquid crystal pixels having light modifying properties controlled by voltage values stored in capacitors located in the matrix of pixels of the LCD. A plurality of digital-to-analog converters (DACs) are coupled through analog switches to columns of the pixel matrix for voltage charging of the columns. Row analog switches connect each column to a desired respective pixel on a selected row, thereby transferring the voltage values on the columns to the respective pixel capacitors. A black pixel border surrounding the video frame of pixels may be used in aligning a color component video frame into correct color convergence with other video frames representing the other color components of a color video frame. The pixels comprising the black border are written as soon as possible before, during and after writing video information to the pixels comprising the video frame.

Referring now to the drawings, the details of preferred embodiments of the invention are schematically illustrated. Like elements in the drawings will be represented by like numbers, and similar elements will be represented by like numbers with a different lower case letter suffix.

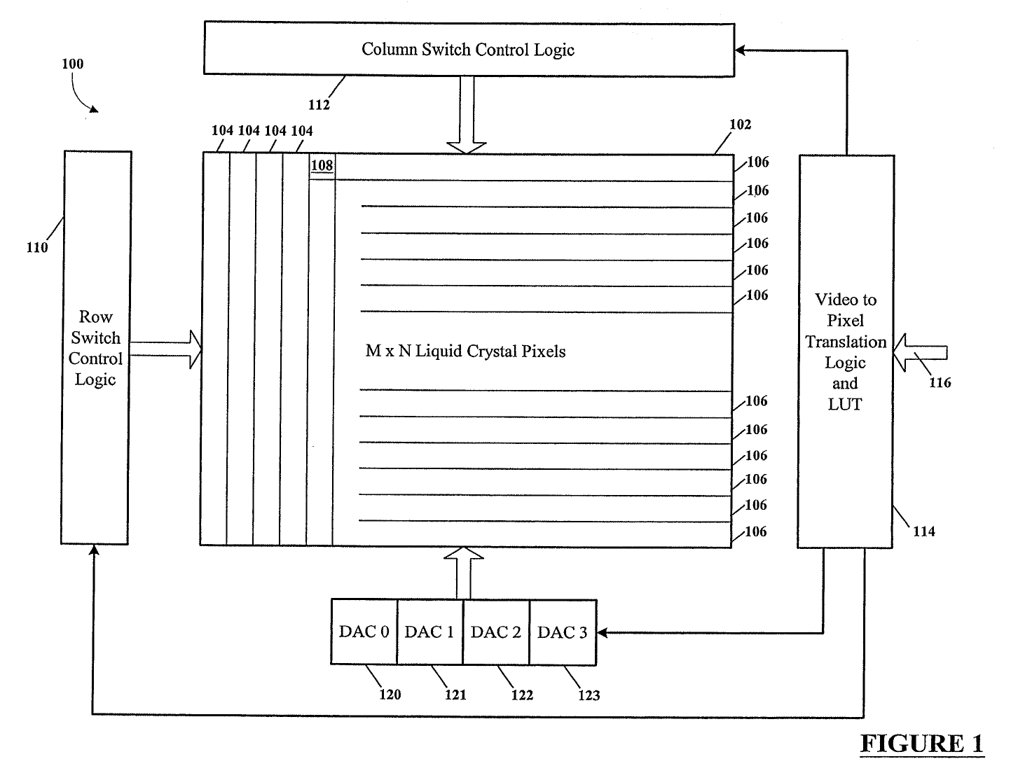

FIG. 1 illustrates a schematic block diagram of a liquid crystal display system in accordance with exemplary embodiments of the present invention. A high-level block diagram of a system for writing voltage values to pixels of a liquid crystal display (LCD) is generally represented by the numeral 100. The voltage values being written to the pixels are representative of a frame of video data. The voltage values control the “twist” of the liquid crystal material at each pixel area so that when a light is flashed on or through the LCD, the light polarization and ultimately the intensity of the light is controlled by the “twist” of the liquid crystal material at each pixel area of the LCD.

For illustrative and exemplary purposes, the LCD 100 depicted in FIG. 1 comprises a pixel matrix 102 of M rows 106 by N columns 104 for a total of M×N individually addressable pixels 108. The combination of row control logic 110 and column control logic 112 are used to select each of the pixels 108 for writing thereto in the LCD 100, as more fully described herein. Video to pixel translation logic and a look-up table (LUT) (hereinafter translation logic) 114 perform the necessary calculations and steps to translate a video frame image 116 into discrete digital values which are sent to digital-to-analog converters (DACs) 120, 121, 122 and 123, and the pixel location addresses thereof are sent to the row and column control logic 110 and 112.

It is contemplated and within the scope of the present invention that any number of DACs may be used according to exemplary embodiments of the present invention. The DACs 120, 121, 122 and 123 have outputs comprising analog values, e.g., voltage or current, corresponding to digital input words from the translation logic 114.

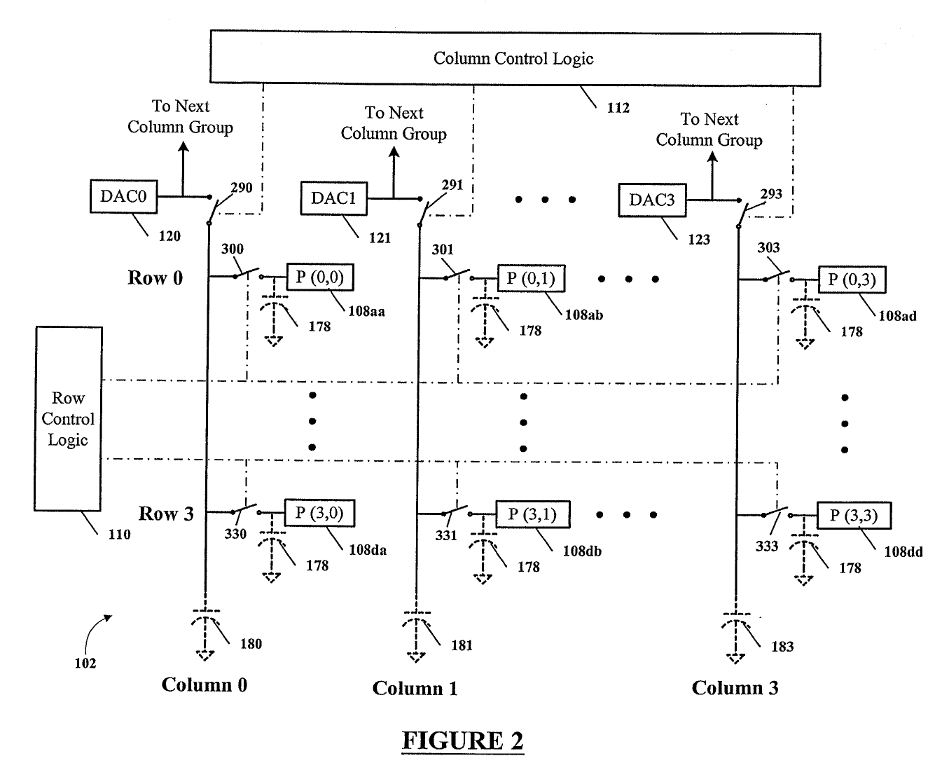

Referring now to FIG. 2, a schematic block diagram of a portion of the liquid crystal display system 100 of FIG. 1 is illustrated. A portion of the pixel matrix 102 is represented for illustrative and exemplary purposes as pixels 108aa-108dd (4×4 matrix), pixel row switches 300 through 333 and pixel column switches 290 through 293. An LCD operates by charging each pixel 108aa-108dd of the LCD 100 to desired voltage values. A voltage at a pixel 108 causes liquid crystals at that pixel area to change their “twist” orientation so that light passing through the LCD 100 or being reflected is thereby affected. The translation logic 114 uses the received video frame information 116 to create appropriate digital values that are sent to the DACs which are representative of that portion of the video frame at each one of the pixel locations. In addition, the translation logic 114 associates an x-y coordinate (row-column) location for each of these pixel voltage values and sends same to the row control logic 110 and column control logic 112.

The DACs 120-123 receive digital representations of video pixel values from the translation logic 114 and convert these digital representations to analog values, e.g., voltage or current, which must then be applied to each corresponding column 104. Each of the pixels 108aa-108dd has a capacitance 178 associated therewith, and each of the columns 0, 1 and 3 has a capacitance 180, 181 and 183, respectively, associated therewith. The capacitance 178 of each pixel may not all be the same, nor may the capacitance 180, 181 and 183 of each column be the same. However, a column capacitance, e.g., 180 is greater than a pixel capacitance, e.g., 178. The column capacitance is charged to a desired voltage value. The output of the DAC is connected to the column and thereby charges the column capacitance to a desired analog voltage, each pixel in a selected row is connected to a corresponding column. Therefore, the voltage on the pixel will be substantially the same as the voltage on the corresponding column.

For example, a column(s) is charged to a certain voltage while a pixel row is selected so that the intersection(s) thereof is the desired pixel to be charged. For example, columns 0-3 are charged from the DACs 120-123, respectively, when the column switches 290-293 are closed. Pixels 108aa-108dd are charged from the columns 0-3, respectively, when the row switches 300-303 are closed. A plurality of DACs may be used to simultaneously charge a like number of columns, then a like number of switches in a row may be used to charge a like number of pixels from the respective charged columns. The column control logic 112 and row control logic 110 control operation of the column switches 290-293 and row switches 300-333, respectively, for the group of pixels 108aa-108dd. Other pixel groups 108 are controlled in a similar fashion.

In an LCD, row and/or column selection need not be sequential, nor is an LCD system limited to selecting only one row and/or column at a time. In exemplary embodiments of the invention described herein, more than one row may be selected and connected to the columns (sequentially or non-sequentially) and more than one column may be connected to the output of a DAC, thereby allowing a plurality of pixels in a plurality of rows to be written at the same time to the same voltage value. This feature of the LCD system enables a plurality of pixels in a plurality of rows and/or columns to be written to black at the same time. In addition, this may be accomplished using only one DAC output. Writing border pixels black at the same time allows more time for writing the video pixels so that the video pixels may be written at a slower rate. A slower writing rate allows a slower clock speed which helps in reducing visual artifacts on the LCD.

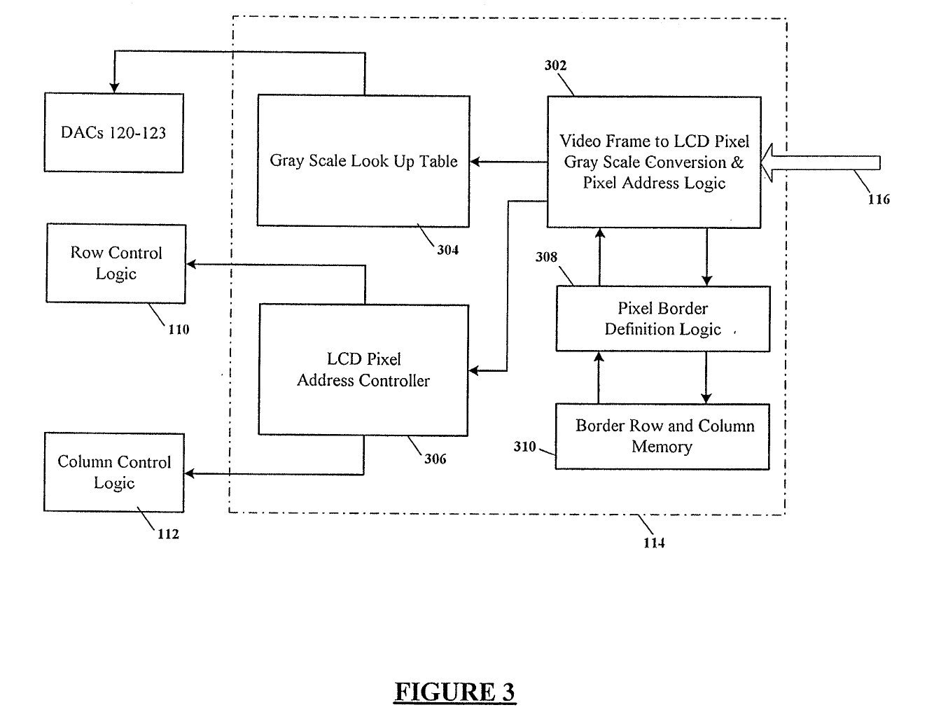

Referring now to FIG. 3, a schematic block diagram of an exemplary embodiment of the invention is illustrated. The DACs 120-123 are adapted to receive digital amplitude information from a gray scale look up table 304. The gray scale look up table 304 receives pixel grayscale information from the video frame to LCD pixel gray scale conversion and pixel address logic 302 which is adapted to convert video information 116 into corresponding pixel information (grayscale and pixel address information). Pixel address information is sent to an LCD pixel address controller 306 which is adapted to control the row control logic 110 and column control logic 112 (FIG. 1).

Pixel border definition logic 308 determines which of the pixel rows and portions thereof that form a black pixel border around the pixels of the video frame. In an exemplary embodiment, the pixel border definition logic 308 is adapted for instructing the video frame to LCD pixel gray scale conversion and pixel address logic 302 to write pixels to black as soon as possible for the top rows of the black pixel border and continue writing to black pixels until pixels of a selected row require gray scale values representing video information. After a row of pixels is written with gray scale information, the remaining row pixels are written to black as border pixels and the next selected row border pixels are written to black until gray scale video information is required for that row of pixels. Once the last pixel requiring video information is written, the remaining pixels on that last video information pixel row are written to black and the subsequent remaining bottom border rows are also written to black.

In another exemplary embodiment, the pixel border definition logic 308 is adapted for instructing the video frame to LCD pixel gray scale conversion and pixel address logic 302 to write the top and bottom border row pixels to black before video frame writing begins, e.g., video information is available. In addition, more than one row 106 and/or column 104 may be selected, e.g., connected together, therefore, a plurality of rows of pixels may be written to black in one operation (e.g., step, clock, etc.). In this embodiment, a plurality of rows 106 may be connected to the columns 104 so that all of the pixels 108 at the intersection of those plurality of rows 106 and columns 104 are written to black when the columns 104 are charged to a black voltage level. Another exemplary embodiment connects a plurality of the columns 104 together so that only one DAC need be used to charge these connected columns to a black voltage. Thus, the pixels 108 at the intersection of the plurality of rows 106 connected to the plurality of columns 104 connected together may be written to black at the same time.

Border row and column memory 310 is used to store which rows 106 and portions thereof are used as the border. The number of border rows 106 above and below the video frame may change during color convergence adjustments as well as the number of border columns 104 to the left and right of the video frame. The rows 106 and portions thereof used as borders may change after a color convergence has been performed, therefore the border row and column memory 310 is adapted to store such a change in the border rows and columns.

It is contemplated and within the scope of the present invention that the pixel border definition logic 308 and/or the border row and column memory 310 may be located in the microdisplay integrated circuit die. A microdisplay may be adapted to write the border pixels in any fashion described herein without external logic intervention, e.g., border pixel writing becomes transparent to the electronic circuits supplying the video information. The microdisplay may store aspect ratio and convergence information during a setup or initialization time, then pixel border wiring will become independent from video frame processing, thus relieving some of the processing load from the video driver electronic circuits.

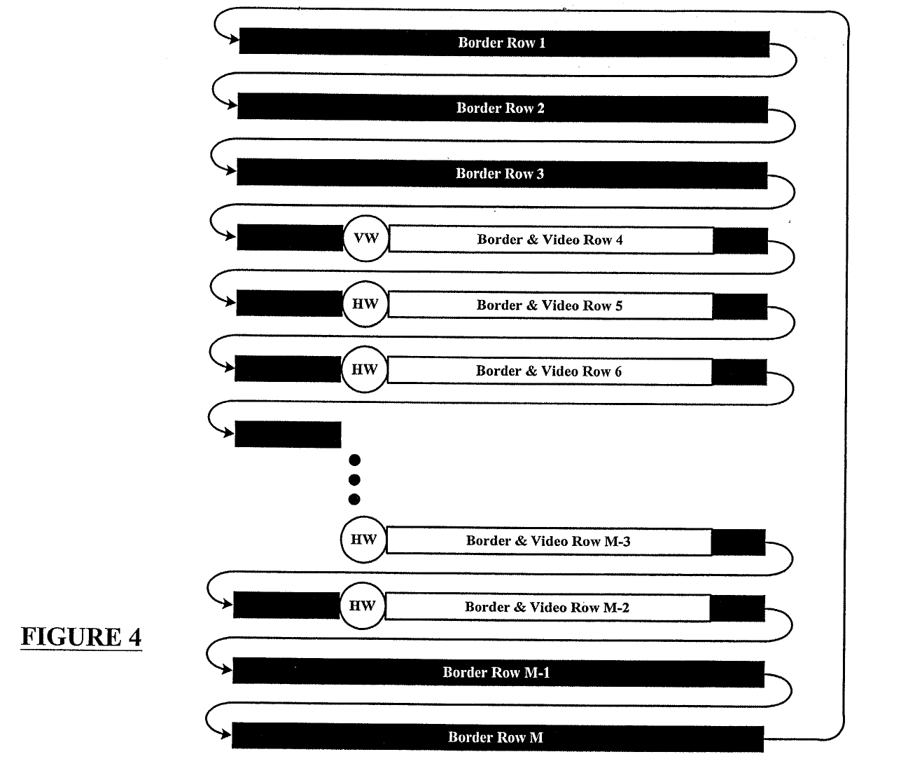

Referring now to FIG. 4, a schematic diagram of fast border row writing in a LCD having M rows, according to an exemplary embodiment, is illustrated. A video frame having a black pixel border comprises rows 1, 2, 3, M−1 and M as horizontal borders, and rows 4 through M−2 as video frame rows of which left and right portions thereof are used as vertical borders. The horizontal border rows and those portions of a vertical border row are written to black as soon as possible, e.g., before or during the conversion of the video information 116 into pixel gray scale information by the gray scale look-up table 304 for writing to pixels in the video frame area (rows 4 through M−2). Initially, the pixels in rows 1-3, and the left portion of row 4 are written to black, then pixel writing stops at “VW” or vertical wait until pixel video frame information is available for that row. As soon as the video information has been written to the video frame pixels in row 4, the remaining border pixels (right border portion) in row 4 are written to black. Then row 5 is selected and the left border pixel(s) of row 5 are written to black until the first video frame pixel in row 5 at “HW” or horizontal wait is encountered. The LCD system then waits until the video information 116 is converted in the gray scale look-up table 304 before proceeding. Rows 5 through M−2 are written to the black border and video frame information as described above. Once the last pixel of video frame information has been written to (end of frame), the right portion of the border of row M−2 and the bottom horizontal border rows M−1 and M are written to black.

There is a polarity change of the pixel charging voltages (either negative or positive inversion), then the top horizontal black border pixels are written to black as soon as possible thereafter. Writing the border pixels to black continues until the pixel at VW is reached, e.g., then a vertical sync and a first line of valid video information occurs before writing resumes. Then as each row (line) of the video frame is written the trailing (right) border is written to, the next row of pixels is selected and the left border is written to black until the pixel at HW is reached. There the writing stops until the next video data enable is received which indicates valid video frame information for that row (frame line).

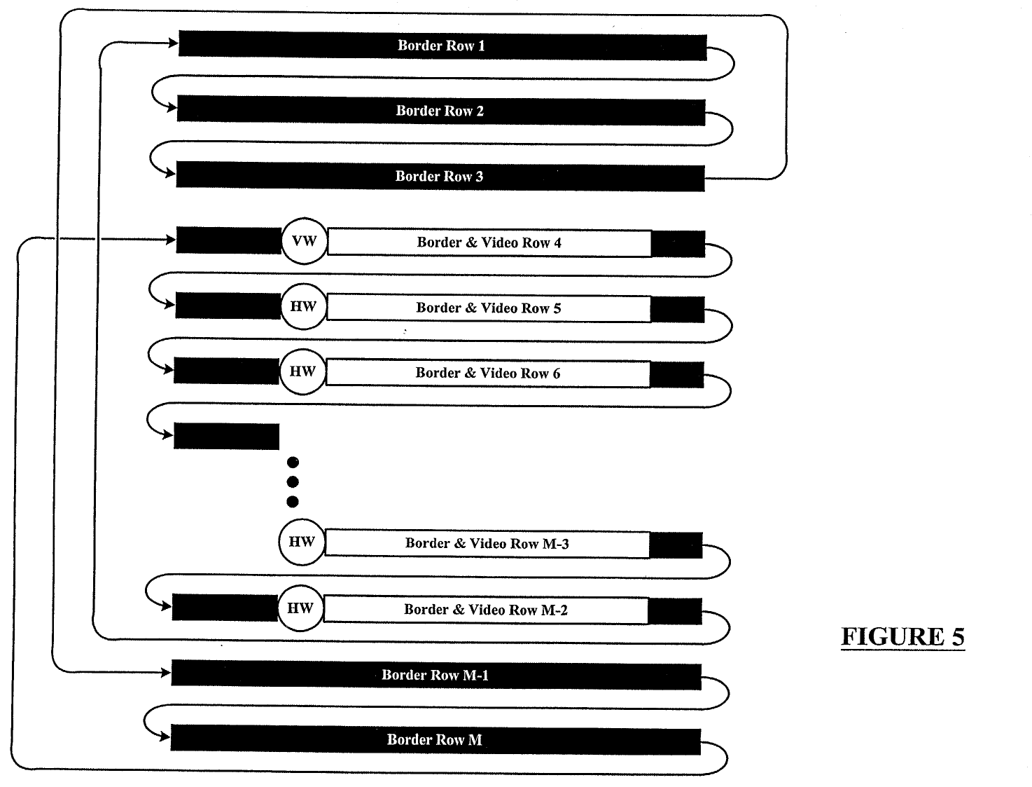

Referring now to FIG. 5, a schematic diagram of fast border row writing in a LCD having M rows, according to another exemplary embodiment, is illustrated. A video frame having a black pixel border comprises rows 1, 2, 3, M−1 and M as horizontal borders, and rows 4 through M−2 as video frame rows of which left and right portions thereof are used as vertical borders. The horizontal border rows and those portions of a vertical border row are written to black as soon as possible, e.g., before or during the conversion of the video information 116 into pixel gray scale information by the gray scale look-up table 304 for writing to pixels in the video frame area (rows 4 through M−2). Initially, the pixels in rows 1-3, M−1, M and the left portion of row 4 are written to black, then pixel writing stops at “VW” or vertical wait until pixel video frame information is available for that row. As soon as the video information has been written to the video frame pixels in row 4, the remaining border pixels (right border portion) in row 4 are written to black. Then row 5 is selected and the left border pixel(s) of row 5 are written to black until the first video frame pixel in row 5 at “HW” or horizontal wait is encountered. The LCD system then waits until the video information 116 is available from the gray scale look-up table 304 before proceeding. The pixels in rows 5 through M−2 are written, as appropriate, to the black border and video frame information as described above. Once the last pixel of video frame information has been written (end of frame), the right portion of the border of row M−2 is written to black.

There is a polarity change of the pixel charging voltages (either negative or positive inversion), then the top and bottom horizontal black border row pixels are written as soon as possible thereafter, and continues until the pixel at VW (row 4) is reached, e.g., then a vertical sync and a first line of valid video information occurs before writing resumes. Then as each pixel in a row (line) of the video frame is written the pixels in the trailing (right) border are written to black, the next row of pixels is selected and the left border pixels are written to black until the pixel at HW is reached. There the writing stops until the next video data enable is received which indicates valid video frame information for that row (frame line).

According to the present invention, writing to black the pixels of the border without having to wait for valid video frame information (e.g., during receipt and conversion of the video information 116) minimizes the LCD pixel matrix writing time required to write a frame of video information, including the border. The top and bottom rows of border pixels may be connected to their respective columns at the same time for faster writing of these pixels to black. In addition, a plurality of columns may connected to the DAC output for a further savings of time in writing the border pixels to black, e.g., fewer columns have to be sequentially addressed.

It is contemplated and within the scope of the embodiments of the invention that the LCD and/or portions of the LCD system may be partially or entirely fabricated on a semiconductor integrated circuit or circuits.

The invention, therefore, is well adapted to carry out the objects and attain the ends and advantages mentioned, as well as others inherent therein. While the invention has been depicted, described, and is defined by reference to exemplary embodiments of the invention, such references do not imply a limitation on the invention, and no such limitation is to be inferred. The invention is capable of considerable modification, alternation, and equivalents in form and function, as will occur to those ordinarily skilled in the pertinent arts and having the benefit of this disclosure. The depicted and described embodiments of the invention are exemplary only, and are not exhaustive of the scope of the invention. Consequently, the invention is intended to be limited only by the spirit and scope of the appended claims, giving full cognizance to equivalents in all respects.

What is claimed is:

1. A system for minimizing frame writing time of a liquid crystal display (LCD), said system comprising:
a matrix of pixels arranged in a plurality of columns and a plurality of rows, wherein an intersection of a row and a column defines a location of a pixel in said matrix;
at least one digital-to-analog converter (DAC) having a digital input and an analog output;
a plurality of column switches adapted for coupling the analog output of said at least one DAC to each of said plurality of columns;
a plurality of row switches adapted for selectively coupling each of said plurality of rows to said plurality of columns;
column control logic for controlling said plurality of column switches;
row control logic for controlling said plurality of row switches;
a video frame to gray scale conversion and pixel address logic for converting video information into LCD gray scale values and corresponding pixel address locations thereof;
said video frame to gray scale conversion and pixel address logic being adapted for sending said gray scale values to said at least one DAC, and said corresponding pixel address locations for controlling said column control logic and said row control logic;
border definition logic adapted to instruct said video frame to gray scale conversion and pixel address logic which pixels are to be used as a border for other pixels of said matrix used to represent a video frame, wherein border gray scale values are written to border pixels before, during and after video gray scale values are available for writing to video frame pixels.

2. The system of claim 1, further comprising a border memory for storing address locations of border pixels, said border memory is coupled to said border definition logic.

3. The system of claim 2, further comprising a logic circuit for changing said address location of border pixels in said border memory.

4. The system of claim 1, wherein each pixel in said matrix comprises a pixel capacitor and liquid crystal material located between said pixel capacitor plates, and said pixel capacitor is coupled to a respective one of said plurality of row switches

5. The system of claim 1, wherein a frame of video is started on said matrix of pixels by writing to all border pixels the border gray scale values in at least one top border row until reaching a pixel position requiring video gray scale values.

6. The system of claim 5, wherein border pixels are written to the border gray scale values after video pixels of a row are written to respective video gray scale values.

7. The system of claim 6, wherein border pixels are written to the border gray scale values in at least one bottom border row until reaching a last pixel position of said matrix.

8. The system of claim 1, wherein a frame of video is started on said matrix of pixels by writing to all border pixels the border gray scale values in at least one top border row and at least one bottom border row until reaching a pixel position requiring video gray scale values.

9. The system of claim 8, wherein border pixels are written to the border gray scale values after video pixels of a row are written to respective video gray scale values until all pixels in said matrix on written to.

10. The system of claim 1, further comprising a gray scale look-up table coupled between said video frame to gray scale conversion and pixel address logic and said at least one DAC.

11. The system of claim 1, wherein said LCD, said plurality of column switches and said plurality of row switches are fabricated on a semiconductor integrated circuit.

12. A method for minimizing frame writing time of a liquid crystal display (LCD) comprising a matrix of pixels arranged in a plurality of rows and columns, wherein an intersection of a row and a column defines a position of a pixel in the matrix, said method comprising the steps of:
(a) writing border information to pixels until reaching a pixel position requiring video information;
(b) waiting until said video information is available, then writing said video information to pixels at positions requiring said video information until reaching a pixel position requiring said border information, then writing said border information to pixels at positions requiring said border information; and
(c) determining if all pixels in the matrix have been written to,
(i) if not, then returning to step (a)
(ii) if so, then begin writing a next frame.

13. The method of claim 12, wherein the steps of writing frames includes the step of inverting voltages written to the matrix of pixels when writing the next frame.

14. The method of claim 12, further comprising the step of storing positions of border pixels.

15. The method of claim 14, wherein the step of storing positions of border pixels comprises the step of storing which rows and columns define said positions of border pixels.

16. A method for minimizing frame writing time of a liquid crystal display (LCD) comprising a matrix of pixels arranged in a plurality of rows and columns, wherein an intersection of a row and a column defines a position of a pixel in the matrix, said method comprising the steps of:
(a) writing border information to pixels in at least one row until reaching a pixel position requiring video information;
(b) waiting until said video information is available, then writing said video information to pixels starting at said pixel position requiring video information in said row until reaching a pixel position requiring border information, then writing border information to the remaining pixels in said row; and
(c) determining if all pixel positions for all rows and columns of the matrix have been written to,
(i) if not, then returning to step (a)
(ii) if so, then begin writing a next frame.

17. The method of claim 16, wherein the steps of writing frames includes the step of inverting voltages written to the matrix of pixels when writing the next frame.

18. The method of claim 16, further comprising the step of storing positions of border pixels.

19. The method of claim 18, where in the step of storing positions of border pixels comprises the step of storing which rows and columns define said positions of border pixels.

20. A method for minimizing frame writing time of a liquid crystal display (LCD) comprising a matrix of pixels arranged in a plurality of rows and columns, wherein an intersection of a row and a column defines a position of a pixel in the matrix, said method comprising the steps of:
(a) writing border information to all rows of pixels not requiring video information;
(b) writing border information to pixels in a row until reaching a pixel position requiring video information;
(c) waiting until said video information is available, then writing said video information to pixels starting at said pixel position requiring video information in said row until reaching a pixel position requiring border information, then writing border information to the remaining pixels in said row; and
(d) determining if all pixel positions for all rows and columns of the matrix have been written to,
(i) if not, then returning to step (b)
(ii) if so, then begin writing a next frame.

21. The method of claim 20, wherein the steps of writing frames includes the step of inverting voltages written to the matrix of pixels when writing the next frame.

22. The method of claim 20, further comprising the step of storing positions of border pixels.

23. The method of claim 22, wherein the step of storing positions of border pixels comprises the step of storing which rows and columns define said positions of border pixels.

24. The method of claim 20, wherein during the step of writing border information to all rows of pixels not requiring video information, all of said pixels having a common column are written at the same time.

25. The method of claim 20, wherein during the step of writing border information to all rows of pixels not requiring video information, all of said pixels are written at the same time.

26. A system for minimizing frame writing time of a liquid crystal display (LCD), said system comprising:
a matrix of pixels arranged in a plurality of columns and a plurality of rows, wherein an intersection of a row and a column defines a location of a pixel in said matrix;
at least one digital-to-analog converter (DAC) having a digital input and an analog output;
a plurality of column switches adapted for coupling the analog output of said at least one DAC to each of said plurality of columns;
a plurality of row switches adapted for selectively coupling each of said plurality of rows to said plurality of columns;
column control logic for controlling said plurality of column switches;
row control logic for controlling said plurality of row switches;
a video frame to gray scale conversion and pixel address logic for converting video information into LCD gray scale values and corresponding pixel address locations thereof;
said video frame to gray scale conversion and pixel address logic being adapted for sending said gray scale values to said at least one DAC, and said corresponding pixel address locations for controlling said column control logic and said row control logic;
border definition logic adapted to instruct said video frame to gray scale conversion and pixel address logic which pixels are to be used as a border for other pixels of said matrix used to represent a video frame, wherein border gray scale values are written to border pixels before video gray scale values are available for writing to video frame pixels.

27. A method for minimizing frame writing time of a liquid crystal display (LCD) comprising a matrix of pixels arranged in a plurality of rows and columns, wherein an intersection of a row and a column defines a position of a pixel in the matrix, said method comprising the steps of:
(a) writing border information to all pixels not requiring video information;
(b) waiting until video information is available, then writing said video information to pixels starting at pixel positions requiring video information; and
(c) determining if all video pixel positions for all rows of the matrix have been written to,
(i) if not, then returning to step (b)
(ii) if so, then begin at step (a).

28. The method of claim 27, wherein the steps (a)-(c) cycle through a positive inversion and a negative inversion.

29. The method of claim 27, wherein the steps (a)-(c) continuously cycle through positive and negative inversions.
